(19) United States
(12) Patent Application Publication
(10) Pub. No.: US 2008/0182054 A1
(43) Pub. Date: Jul. 31, 2008

(54) Multi-function vacuum bag for composite part manufacture

(76) Inventors: Michael D. Ridges, American Fork, UT (US); William T. McCarvill, Salt Lake City, UT (US)

Correspondence Address: THORPE NORTH & WESTERN, LLP., P.O. Box 1219, SANDY, UT, 84091-1219, US

(21) Appl. No.: 12/008,400

(22) Filed: Jan. 9, 2008

Related U.S. Application Data
(60) Provisional application No. 60/879,725, filed on Jan. 9, 2007.

(51) Int. Cl. B32B 27/00; B29C 41/42; B29C 65/70

(52) U.S. Cl. 428/35.2; 264/334; 264/308; 264/241

(57) ABSTRACT

A multi-function vacuum bag for use in the manufacture of composites, wherein the vacuum bag may be configured to provide all-in-one capabilities, namely to function as the vacuum bag, a caul or caul sheet, release layer and/or a breather, as well as to provide other functions. Specifically, the multi-function vacuum bag allows a separate breather or breather material, a separate caul or caul layer, and a release or release layer all to be eliminated, if desired, as the multi-function vacuum bag is capable of performing the functions of each of these once formed. Furthermore, the multi-function vacuum bag may be used with various composite manufacturing process, such as VARTM or resin infusion processes, various vacuum bagging processes, filament winding processes, and others.

### RELATED APPLICATIONS

This application claims the benefit of U.S. Provisional Application No. 60/879,725, filed Jan. 9, 2007, and entitled, “Multi-Function Vacuum Bag for Composite Part Manufacture,” which is incorporated in its entirety herein.

### FIELD OF THE INVENTION

The present invention relates generally to the fabrication or manufacture of composite articles, and more particularly to the several components and/or materials used to manufacture composite articles.

### BACKGROUND OF THE INVENTION AND RELATED ART

Fiber reinforced resin composite articles are fabricated using one of two basic techniques. In a “dry” lay-up process, fiber forms that have been pre-wetted with resin, forming a “pre-preg” structure, are laid up against a mold to provide the proper shape. The process is “dry” because no new resin is introduced to the fiber forms after the material has been laid up against the mold. In a “wet” lay-up process, a dry fiber reinforcement material, otherwise known as a preform, is laid up on a mold and sprayed, brushed, or otherwise coated or “wetted” with the resin. If the resin employed is of the thermoset type, the piece may then cured at an elevated temperature in an autoclave to form the fiber reinforced plastic structure. In other techniques the resin may be designed to polymerize at ambient temperature.

Composite manufacturing methods can be further distinguished by their use of either closed mold or open mold processes. A common manufacturing method using a closed mold process is the resin transfer molding process (hereinafter “RTM”). RTM is a version of the “wet” lay-up process in which a continuous strand mat or fiber preform is positioned on an open female mold or tool. A rigid, cooperatively shaped male mold is mated to the female mold and the sealing edges of the two are pressed together, creating a cavity of fixed dimensions which encloses the fiber preform. A catalyzed resin mix is thereafter pumped into the cavity formed between the two mold surfaces. After a suitable curing cycle, the part is removed from the mold.

Closed mold methods such as RTM offer several advantages and can be cost effective when molding relatively small articles. Because a closed mold is rigid and easily sealed, the resin can be injected under pressure at one end while at the same time employing a vacuum to remove air from the sealed cavity at the other. Removing air before the resin is introduced reduces the possibly of air pockets and resin voids in the composite matrix and results in a stronger finished product. Another advantage of the closed mold is that as a closed system, all emissions of hazardous fumes can easily be controlled. Yet another benefit is the minimal set-up time; the mold can be used again immediately after the resin is cured and the previous part removed. Finally, because both halves of the closed mold provide rigid, smooth surfaces, the final composite product has a quality surface finish on both sides. Unfortunately, because of the high cost of matched metal dies and high tonnage presses, parts produced with closed molds are generally limited in size and geometry.

As a consequence, most large composite articles, such as boat hulls, are currently manufactured using tooling member or open molds and “wet” lay-up processes. These methods generally involve positioning a mat of fiber reinforcement material in a single tooling member cavity and spraying or flow coating the fiber material with liquid curable resin. A variation of this method involves chopping fiberglass in front of the resin spray stream, depositing the curable resin and the fiber reinforcements simultaneously in the tooling member. A significant drawback to these “wet” open mold methods of fabrication is the release of large amounts of hazardous air pollutants (hereinafter “HAPs”) into the surrounding atmosphere, which is a matter of great concern both to the Environmental Protection Agency (EPA) and the Occupational Safety and Health Agency (OSHA). A solution for reducing HAPs, which is well known in the art, is to enclose the open mold or tooling member and the fiber reinforcement material within an impermeable liner or vacuum bag during application of the resin. This method is formally known as Vacuum Assisted Resin Transfer Molding (hereinafter “VARTM”), but is more commonly referred to as an “infusion” process.

In VARTM processing, the dry fiber mat, or ‘preform’, is applied over a mold surface to form a lay-up of fiber reinforcement material of desired thickness. Resin injection ports and vacuum suction ports are installed at selected locations around the preform lay-up, and a flexible, gas impervious sheet, liner, membrane, film, or bag (hereinafter “bag”) is placed over the entire assembly. The edges of the bag are clamped or sealed around the periphery of the mold to form a sealed vacuum envelope surrounding the preform lay-up. A vacuum source is placed in pneumatic or fluid communication with the space between the tooling member and the bag and is used to draw a vacuum and to create a negative pressure within the sealed vacuum envelope. Resin is then introduced, or ‘infused’, into the interior of the vacuum bag after negative pressure is applied. Under ideal circumstances, the induced negative pressure serves to shape the article to the mold, to draw the resin through the fiber mat, completely “wet” the fiber, and to remove any air that might cause the formation of voids within the completed article. The negative pressure is maintained while the wetted fiber is pressed and cured against the mold to form the fiber reinforced composite structure or part having the desired shape. Once the composite part is fully cured, the bag is normally removed from the molded article and discarded as waste.

The use of an impermeable bag offers a significant advantage as HAPs generated from resin transfer are greatly reduced. However, it also creates a host of new manufacturing difficulties which, in turn must be overcome. One ongoing concern is the potential formation of air pockets or voids in the composite part that can result in both structural deficiencies and reduced aesthetics. As the bag is normally a thin, flat sheet laid upon the fiber preform, which is in turn laid up against the contoured surface of the tooling member, the bag must be carefully folded or cut and taped to conform to the shape of the finished part. Any location where the bag is folded, wrinkled or bunched together creates the potential for a pocket of air, gas, or vapor to form between the bag and the fiber preform. Additionally, wrinkles can also form on the surface of the bag during setup, which allow excess resin to accumulate between the bag and the fiber preform, permanently transferring the impression of the wrinkle to the surface of the completed composite part. Although slowing down the evacuation process can reduce the occurrence of air pockets and wrinkles, it also results in reduced production rates, and therefore increased costs.

Any taped seam in the bag also creates the potential for a pinhole leak, which will cause air to be introduced into the resin stream. This problem causes a quality issue commonly called “bubble trails.” Such defects that are not corrected during the molding process require costly reworking. Moreover, if the bag is of inadequate thickness, the induced negative pressure may draw portions of the bag film down into the intricacies in the fiber preform to partially block the flow of the resin. This phenomenon may require additional flow time to allow the affected area to be filled from another direction, and may also result in a structural defect caused by incomplete wetting of the fiber preform by the resin.

The method of properly installing traditional bags is labor-intensive, especially for very large structures, such as boat hulls. Trained technicians must accurately lay the bag over the contoured surface of the tooling member and fiber preform, and attention must be taken when taping and sealing the outer edges of the bag against the sealing surfaces around the periphery of the tooling member. Special care is required when installing the resin injection and vacuum suction ports to properly tape and seal the holes in the bag. Furthermore, additional up-front effort must also be spent assembling resin supply and vacuum suction manifolds which connect to the injection and vacuum ports. These piping systems are normally disposable as they become clogged with the resin after each use and must be discarded.

In the typical VARTM process every step in assembling the vacuum bag must be duplicated each time a part is built. It is recognized that it is costly to discard the completed vacuum bag after each use, but as the bag film must be thin and flexible in order to be applied in the first place, it lacks the structural integrity to withstand removal, cleaning and repositioning without tearing. Therefore, the expensive process of manually assembling the vacuum bag by laying down the bag film, attaching the injection and vacuum ports, and sealing the periphery of the bag against the tooling member must be repeated for each new composite structure which is to be built using the resin infusion process.

A similar problem exists with the bags used in traditional vacuum bagging processes, which have long been used to fabricate laminated composite articles comprised of composite materials that are adhesively bonded together. To make a composite or laminated article using a traditional process, a few thin layers of “pre-preg” fiber reinforcement material are stacked upon the forming surface portion of a tooling member. A flexible gas impervious vacuum bag, similar to the one discussed above, is then placed over the composite or laminated article. To seal the bag, a tacky or other similar tape, such as chromium tape, is continuously applied between the bag and the periphery of the tooling member. Thus, a volume defined by the bag and the tooling member is sealed off.

A vacuum source is placed in pneumatic or fluid communication with the space between the forming tool and the bag and is used to create a negative pressure in the sealed off volume. The creating of the negative pressure performs several functions. First, the bag is firmly pressed against the pre-preg fiber material laid up on the tooling member, thereby forming the materials to the shape of tooling member. The vacuum also draws out any pockets of air which were left trapped between the plies of pre-preg material, consolidating the layers into a tighter laminate structure. What is left is a few layers of a tight composite, laminate structure which may be further built up to produce a light-weight, high-strength laminated or composite article.

When the vacuum induces an internal collapse of the bag against the prepreg fiber reinforcement, the bag has a tendency to restrict the air from freely flowing through the fiber reinforcement, trapping pockets of air and other vapors between the bag and the composite structure. To counteract this problem, a breather layer with a permeable release film may be positioned between the pre-preg lay-up and the inside of bag. The breather layer stops the bag from completely collapsing on the lay-up and allows for all excess air and gas to escape the consolidating structure. For each consolidation/debulking step in the vacuum bag process, a few plies of pre-preg fiber reinforcement are placed on the previous lay-up, a release film is applied over the pre-preg material, followed by the breather layer. The entire assembly is then sealed with the vacuum bag and a vacuum is drawn. The above steps are repeated to produce the finished composite or laminated article having a large number of plies. Sheets of honeycomb core can also be laid upon or between layers of composite material to produce panels of various shapes and sizes. An additional step of heating the composite or laminated article while under pressure in an oven or pressurized autoclave oven can be used to cure the adhesive resins in and between the plies of the laminated materials.

Unfortunately, conventional vacuum bags that comprise a plastic sheet and that require a sealing tape for sealing against the mold are not robust and durable, and cannot be used to apply more than a few layers of laminates before they must be discarded and replaced. Thus, when a given composite or laminated article is produced, a skilled worker must fashion the vacuum bag and then attempt to use it for as many operations as possible. Fabricating a vacuum bag for each article in a production run is time consuming and expensive. Moreover, for parts with many layers a large quantity of used vacuum bags will be discarded, adding undesirable solid waste.

Attempts have been made to provide a reusable vacuum bag and to eliminate many of the problems discussed above. One particular technique discussed in the prior art involves applying a viscous silicone rubber compound in multiple coats over the same open mold used to manufacture the composite part. The viscous silicone cannot be applied by spraying, but instead must be poured or brushed onto the tooling member. Moreover, the bag cannot be manufactured quickly as each layer of silicone rubber takes time to set before the next layer is applied. Finally, because of its high density and weight a silicone rubber bag does not work well with large open mold tooling members like those used to fabricate boat hulls. Such a large bag would be too unwieldy and likely to tear under its own weight if handled improperly.

### SUMMARY OF THE INVENTION

In light of the problems and deficiencies inherent in the prior art, the present invention seeks to overcome these by providing a multi-function vacuum bag that provides all-in-one capabilities, namely to function as the vacuum bag, a caul or caul sheet, release layer, a breather, and various other materials. In other words, the present invention vacuum bag is comprised of a suitable composition having properties that allow the vacuum bag to inherently provide all of the necessary functions needed during a vacuum bagging process, without requiring these separate and independent components.

In accordance with the invention as embodied and broadly described herein, the present invention resides in a method for forming a multi-function vacuum bag for use in the manufacture of a composite article, said method comprising applying a prepolymer composition configured for rapid polymerization at ambient temperatures over a surface; rapidly polymerizing said prepolymer composition to form a multi-function vacuum bag having a periphery and a shape substantially conforming to said surface; removing said vacuum bag from said surface; and applying said formed vacuum bag within a composite article manufacturing process.

The present invention also resides in a method for making a multi-function vacuum bag for use in a process for the manufacture of a composite article, said method comprising obtaining an isocyanate component comprising an isocyanate building block connected to a flexible link with a urethane bond; obtaining a resin blend component comprising an amine-terminated polymer resin; mixing said isocyanate component with said resin blend component to obtain a polyurea prepolymer composition, said polyurea prepolymer mixture being configured for rapid polymerization at ambient temperatures; applying said polyurea prepolymer composition over a surface; rapidly polymerizing said polyurea prepolymer composition to form a multi-function vacuum bag having a periphery and a shape substantially conforming to said surface; and removing said vacuum bag from said surface.

The present invention further resides in a method for forming a multi-function vacuum bag for use in a process directed at the manufacture of a composite article, said method comprising positioning a spacer within a tooling member, said spacer having a first surface corresponding in size and configuration to a working surface of said tooling member, and a second elevated surface also corresponding in size and configuration to said working surface of said tooling member, said second elevated surface having a different scaled size than said working surface of said tooling member; applying a prepolymer composition configured for rapid polymerization at ambient temperatures over said second elevated surface of said spacer; rapidly polymerizing said prepolymer composition to form a multi-function vacuum bag having a periphery and a shape substantially conforming to said surface of said spacer; removing said vacuum bag from said surface of said spacer; and applying said formed vacuum bag within a composite article manufacturing process.

The present invention still further resides in a method for manufacturing a composite article comprising obtaining a tooling member defining a working surface; pre-forming a multi-function vacuum bag operable with the working surface, said multi-function vacuum bag comprising a prepolymer composition; disposing a composite lay-up about said working surface of said tooling member, said composite lay-up being adapted to form a composite article; applying said pre-formed multi-function vacuum bag about said composite lay-up; and performing further processing steps to complete fabrication of said composite article.

The present invention still further resides in a method for manufacturing a composite article comprising obtaining a tooling member defining a working surface; disposing a composite lay-up about said working surface of said tooling member, said composite lay-up being adapted to form a composite article; applying a prepolymer composition configured for rapid polymerization at ambient temperatures over a surface of said composite lay-up; rapidly polymerizing said prepolymer composition to form a multi-function vacuum bag having a periphery and a shape substantially conforming to said surface of said composite lay-up, said multi-function vacuum bag being operable with said tooling member to seal said composite lay-up; and performing further processing steps to complete fabrication of said composite article.

The present invention still further resides in a multi-function vacuum bag comprising a prepolymer composition comprising a polyurea-based composition formed by mixing an “A” side isocyanate component with a “B” side resin blend component; and a configuration operable to facilitate fabrication of a composite article.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations.

Nonetheless, the invention will be described and explained with additional specificity and detail through the use of the accompanying drawings in which:

FIG. 1 illustrates a perspective view of an exemplary embodiment of an improved vacuum bag forming system for the manufacture of composite parts, wherein a reusable vacuum bag is formed by spraying a prepolymer mixture onto an open mold;

FIG. 2-A illustrates a perspective, cut-away view of the embodiment of FIG. 1, in which additional optional components have been added to structure of the reusable vacuum bag;

FIG. 2-B illustrates a cut-away side view of a multifunction vacuum bag having one or more areas of increased thickness to allow the vacuum bag to function as a caul;

FIG. 2-C illustrates a cut-away side view of a multi-function vacuum bag having a reinforcement member integrally formed therein to allow the vacuum bag to function as a caul;

FIG. 3 illustrates a flow diagram of a method for forming a multi-function vacuum bag in accordance with one exemplary embodiment of the present invention;

FIGS. 4-A-4-C illustrate various side views depicting an exemplary method of forming a multi-function vacuum bag in accordance with the present invention, wherein a prepolymer mixture is sprayed over a tooling member containing a spacer to form a multi-function vacuum bag having the shape of a finished composite part lying in the tooling member;

FIG. 5 illustrates a perspective, cut-away view depicting an exemplary VARTM process utilizing the present invention multi-function vacuum bag, wherein the multi-function vacuum bag is positioned over a lay-up of fiber preform on a tooling member;

FIGS. 6-A-6-B illustrate various side views of the depicted method of FIG. 5, in which the VARTM process is used in conjunction with the multi-function vacuum bag to form a composite article;

FIG. 7 illustrates a flow diagram of a method for forming a composite article using the VARTM process and a multi-function vacuum bag in accordance with the present invention;

FIG. 8 illustrates an exploded side view depicting an exemplary vacuum bagging process utilizing the present invention multi-function vacuum bag, wherein the multi-function vacuum bag is positioned over a lay-up of prepreg material, peel ply, and release film on a tooling member; and

FIG. 9 illustrates a flow diagram of a method for forming a composite article using a vacuum bagging process and a multi-function vacuum bag in accordance with the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a multi-function vacuum bag for use in the manufacture of composites, wherein the vacuum bag may be configured to provide all-in-one capabilities, namely to function as the vacuum bag, a caul or caul sheet, release layer and/or a breather, as well as to provide other functions. Specifically, the multi-function vacuum bag allows a separate breather or breather material, a separate caul or caul layer, and a release or release layer all to be eliminated, if desired, as the multi-function vacuum bag is capable of performing the functions of each of these once formed. Of course, the present invention multi-function vacuum bag may be utilized with any one or all of these in some circumstances, if so desired. Furthermore, the present invention multi-function vacuum bag may be used with various composite manufacturing process, such as VARTM or resin infusion processes, various vacuum bagging processes, filament winding processes, and others. Stated differently, the multi-function vacuum bag of the present invention can be used for autoclave cures, resin infusion cures, prepreg de-bulking and other processes.

Several applications are contemplated for the multi-function bag of the present invention. Stated differently, the present invention multi-function vacuum bag is intended to replace multiple materials and their functions as currently existing in the art. Although referred to as a “bag” or a “vacuum bag,” this particular application is not meant to be limiting in any way. Specifically, it is contemplated that the material compositions and methods for forming the vacuum bag may be used not only as a vacuum bag in vacuum bagging processes as conventionally thought of, but also for bagging prepreg composites, for cauls, for release films, for consolidation/debulking bags, for infusion bags, for bladders, and for damming borders.

As an autoclave vacuum bag, the multi-function vacuum bag may be a pre-sprayed or pre-formed vacuum bag that is placed over a composite lay-up and a prepared tooling member, and sealed to hold vacuum integrity. When sprayed, the tooling member may be coated with a mold release agent to allow easy removal of the vacuum bag. The vacuum back may also be coated with mold release prior to lay-up. A vacuum may be applied to the pre-preg lay-up through the tooling member, or through sprayable vacuum ports, which are encased or embedded within the vacuum bag. Sprayable vacuum ports can be removed following curing of the composite article. Conventional vacuum ports may also be placed over holes cut into the vacuum bag with conventional bag pieces being sealed to the tool surrounding the port. The vacuum bag may be sprayed directly on to the lay-up to function as a vacuum bag, but in many cases will not be reusable. In this case, the pre-preg may be covered with a similar mold release agent.

The multi-function vacuum bag may be used as a caul, and placed on the top surface of the lay-up, thus eliminating the need for separate caul materials. Thermal forming and elongation characteristics of the material will allow the vacuum bag caul to press into the part for detailed part definition. As with the pre-sprayed bag, the caul may be sprayed prior to lay-up, at the desired thickness, to provide relief for the part to be made. As such, the vacuum bag may function both as a bag and a caul.

The multi-function vacuum bag may also be used as a release layer or release material during various manufacturing steps. As a release layer, the vacuum bag may be coated with a mold release agent.

The multi-function vacuum bag can also be used as a breather layer or breather material, or in other words, may incorporate breather characteristics, thus eliminating existing separate breather materials. The normal texture of the material will allow the drawn vacuum to be distributed throughout the part lay-up surface. For additional air movement a textured multi-function vacuum bag may be created by applying the pre-polymer composition over a textured surface, thus creating a textured imprint in the surface of the bag. This texture can consist of any type of mesh or web material which has connected or raised channels.

The multi-function vacuum bag may also be used as a reusable bag for consolidation/debulking. This allows for quick and easy removal of air and volatiles from a normal pre-preg lay-up, and even the nation of existing nylon debulking processes.

The multi-function vacuum bag may be used for resin infusion processes as it comprises characteristics that make it a better and more desirable material for infusion.

The multi-function vacuum bag may also be used as or configured to function as a bladder for use in a bladder molding process, such as that used to manufacture airplane fuselages. The vacuum bag may be operable with a mandrel in some embodiments. Particular examples of this application are described in U.S. patent application Ser. No. 11/975,226, filed Oct. 17, 2007, and entitled, “Method for Enhancing the Sealing Potential of Formable, Disposable Tooling Materials,” which is incorporated by reference herein in its entirety.

The present invention multi-function vacuum bag comprises a fast setting, fast curing (rapid polymerizing) sprayable prepolymer composition. For example, the sprayable composition may comprise a polyurea-based prepolymer mixture, made by combining an isocyanate component with a resin blend component, such as a polymeric MDI component with a polymeric polyol, or an aromatic isocyanate component with an aromatic polyurea component. An example of some particular types of polymers that may be used and that are well suited for the applications intended herein are those produced by Engineered Polymers International, LLC of Madison, Wis., and marketed as Reactamine®, or as comprising Reactamine® technology. Others include those manufactured by BaySystems North America.

The sprayable prepolymer composition may also comprise a silicone-modified polyurea composition.

The polyurea-based prepolymer mixture forms a coating that rapidly polymerizes at ambient conditions into a flexible, substantially non-porous seal having a shape conforming to the surface to which it is applied (e.g., the surface of the open mold or the surface of the tooling member).

The multi-function vacuum bag of the present invention overcomes the limitations currently existing in the art as it is easily applied with a spray device, sets up quickly and rapidly cures or polymerizes, provides a substantially airtight, non-porous seal, and provides a much higher strength to weight ratio, allowing thinner and lighter layers to be obtained, if so desired, as well as thicker or built-up portions or segments.

The present invention provides several other significant advantages over prior related vacuum bags, some of which are recited here and throughout the following more detailed description. First, the multi-function vacuum bag is multi-faceted in that it is able to function not only as a vacuum bag, but also a caul, if desired. The bag may also be configured to provide for evacuation of air and volatiles during the manufacturing process, similar to what a conventional breather would do. In addition, the bag may be configured to release from the composite article without a separate release film, although one or more may be used if desired. Each of these advantageous properties are made possible by the prepolymer material composition of the vacuum bag, and the method of forming the bag. Second, although various compositions are contemplated, the prepolymer is intended to be engineered in a manner so as to provide a vacuum bag capable of rapid polymerization as the vacuum bag is formed from a quick setting, quick curing prepolymer, to have a non-porous surface, to be able to withstand temperatures between 200° and 500° F., and preferably above 350° F., to be pliable, and to be able to release and be easily removed from the composite article. In some less extreme manufacturing processes, the vacuum bag may also be configured to be reusable. Third, the present invention vacuum bag provides a significant reduction in manufacturing costs as prep time and cycle times are reduced, debulking enhanced, and part quality maintained or even enhanced. Indeed, the multi-function vacuum bag reduces the number of manufacturing processes used to fabricate a composite article, without sacrificing the quality of the article. Fourth, texturing of the composite article is made possible. Fifth, smooth, high tolerance surfaces may be achieved without the use of a rigid upper mold component.

Each of the above-recited advantages, and others as recited herein, will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

The term “prepreg” or “prepreg member” or “prepreg composite material” is short for “pre-impregnated reinforcement fabrics and/or fibers materials.” The prepreg material is generally a “green”, uncured or partially cured composite material, including composites, polymers, plastics, or any other material that utilizes bagging as a part of its process. Prepregs are applicable in a variety of applications, including aerospace, automotive, and recreational products. Generally, prepregs are reinforcement fabrics such as fiberglass, carbon, and mixtures thereof, which receive a resin solution (e.g. epoxy, polyester, etc.) For example, a prepreg may be fabric or foam formed in a honeycomb shape where self-adhesive resin sheets are applied to the outer surface of the honeycomb core structure and partially cured.

The term “resin” or “thermosetting resin” or “thermosetting sealing resin” means polymer that hardens into a permanent predetermined shape, and that is used to bind together the reinforcement material in a composite article. In the present invention the thermosetting resin is a polyurea/polyurethane resin, however, other resins may be applicable to the present invention, such as polymeric resins. The term resin may include derivates, solvates and mixtures thereof.

The term “lay-up” means a preparation process in which components, layers or plies of reinforcing material or resin-impregnated reinforcement material are applied to a surface of the tooling member in preparation for forming molded polymer members.

The term “tooling member,” as used herein, shall be understood to mean a tool for supporting a composite lay-up and for providing shape and structure to a prepreg composite material during the curing process. This term can refer to a mold (e.g., an open mold), a forming tool or a mandrel or disposable tooling core having a working surface in the shape of the desired composite part.

The term “working surface,” as used herein, shall be understood to mean all or part of a surface of a tooling member configured to receive a composite lay-up for the fabrication of a composite article.

The term “ambient,” as used herein, shall be understood to mean conditions of non-elevated temperatures, namely between 60° and 80° F., and non-elevated pressures, namely atmospheric.

The term “rapid polymerization,” as used herein, shall be understood to mean the polymerization of the prepolymer within a relatively short time period, preferably less than five minutes. In some embodiments, polymerization may occur within seconds (e.g., one to thirty seconds) after being mixed and applied, while in other embodiments, polymerization may take place in minutes (e.g., between one and fifteen minutes, and preferably less than three-five minutes).

In one exemplary embodiment, the present invention describes or contemplates a multi-function vacuum bag that is pre-formed, meaning that the vacuum bag is formed prior to being disposed over or about a composite lay-up. In this case, the vacuum bag may be formed by applying or disposing a polyurea-based prepolymer composition over a surface of a tooling member, or any other suitable object (e.g., a spacer, a previously formed composite article, etc.). The polyurea-based prepolymer composition forms a coating designed to rapidly polymerize at ambient conditions into a flexible, vacuum bag having a shape that conforms to the surface to which it was applied. Once the vacuum bag is formed, it may be removed and used thereinafter as a top-sealing layer or cover about a composite lay-up of fiber reinforcement material which has been disposed about a working surface of a tooling member or mold. The tooling member and vacuum bag together create an airtight volume that surrounds the fiber reinforcement material or prepreg lay-up and permits the drawing of a vacuum, a known step in both resin infusion and vacuum bagging processes.

As indicated, a composite material, either a dry fiber preform or a pre-wetted prepreg, may be laid up on the working surface of the tooling member. After the lay-up is complete, the pre-formed vacuum bag may be situated or disposed over the composite material lay-up and sealed around its periphery, forming a gas-tight chamber around the composite material lay-up, which substantially corresponds to the shape of the tooling member surface. Vacuum suction lines and/or resin injection lines may be attached to the various ports as provided in the vacuum bag and the fabrication of the composite article completed, after which the lines are detached and the vacuum bag is removed. Depending upon the environment to which the vacuum bag is exposed (e.g., the temperature and pressure), the vacuum bag may retain its robust and durable characteristics, enough to be repeatedly used for an extended number of vacuum process cycles, which may eliminate many problems inherent in prior related vacuum bags and their associated manufacturing processes.

Preparation of the tooling member or other object to form a pre-formed multi-function vacuum bag can involve a number of specific steps, depending upon the type of composite manufacturing process employed, the size of the intended composite article and the tooling member needed to fabricate such, and the unique requirements for fabricating a custom composite article. The present invention multi-function vacuum bag and methods involving use of the same, accounts for all these variables. In most circumstances the tooling member may be prepared by applying a release layer, and properly positioning or placing the vacuum suction port or ports. A release layer may be applied to the surface of the tooling member prior to application of the prepolymer composition to ensure that the vacuum bag readily releases from the tooling member after polymerization without tearing or ripping. The suction port(s) may be placed on top of the release layer to become encased by the prepolymer composition as it is applied, so that the ports pull away along with the bag when it is removed, or in other words, so that the ports become an integral part of the bag. In a similar fashion, other components may be placed on the tooling member, which components may then become integrally formed with the vacuum bag. These components include, but are not limited to, resin injection ports, fiber reinforcements, and/or various attachment connections to be used in lifting and positioned the vacuum bag after formation.

In situations where a finished composite article is intended to comprise a uniform thickness throughout, or where the thickness dimension is small when compared to the size of the tooling member, a vacuum bag which has been built-up or formed directly from the tooling member itself will provide a tight fit over the dry fiber preform or a pre-wetted prepreg lay-up. However, if the finished composite article is intended to comprise a variable thickness or if its thickness is significant relative to the size of the mold, a spacer part simulating the dimensions of the intended finished composite article may be positioned on the tooling member prior to application of the prepolymer composition. As the prepolymer composition is being applied, the resulting vacuum bag will acquire a shape substantially conforming to that surface of the finished composite article to which the composition is applied.

One method for forming pre-formed vacuum bags which follow the surface shape of a complex composite article is to simply spray the bag over a previously completed composite article loaded into the tooling member. This technique will result in a custom fit vacuum bag which matches the shape and contour of the composite article lying in the tooling member, in essence simulating the upper half of an upper component of a tooling member traditionally used in a closed molding process. Although the vacuum bag is flexible rather than rigid, and although it most likely is not used to apply a positive pressure (except in the case where it is intended to function as a bladder), it can be formed at a fraction of the cost of other prior related vacuum bags, and is highly effective in a VARTM, vacuum bagging, and other composite manufacture processes.

The multi-function bag of the present invention overcomes the limitations currently existing in the art as it is easily applied with a spray device, sets up, cures or polymerizes within seconds or minutes rather than hours or days, and the polymer-based material which makes up the bag has a much higher strength to weight ratio, allowing a far thinner and lighter polymer layer to hold the same vacuum as bags described in the prior art. Moreover, these same characteristics allow the multi-function bag to be used to make very large composite structures, such as boat hulls, aircraft fuselages, etc. as it is lightweight and rigid enough to be maneuvered around large tooling members without disturbing the prepared lay-up.

The method of the present invention also simplifies the process of creating and assembling a new bag by including the integration of resin injection ports, vacuum suction ports, reinforcements, and flow channels within the structure of the bag itself. Yet another advantage is that the vacuum bag may be used with tooling members having a wide variety of sizes and shapes, such as those used in a resin infusion VARTM process and variations thereof, as well as those used in traditional vacuum bagging processes. Moreover, the multi-function vacuum bag reduces the potential for folds and wrinkles in the bag and greatly improves the surface finish of the completed composite article, while at the same time reducing the probability of leaks.

In another exemplary embodiment, the present invention describes or contemplates a multi-function bag that is not pre-formed. In this case, the vacuum bag may be formed by applying or disposing the polyurea-based prepolymer composition directly over a prepreg or other composite lay-up, with the polyurea-based prepolymer composition being intended to rapidly polymerize at ambient conditions into a vacuum bag operable to seal the prepreg about the tooling member, to subsequently permit the drawing of a vacuum, and to generally facilitate fabrication of the composite article.

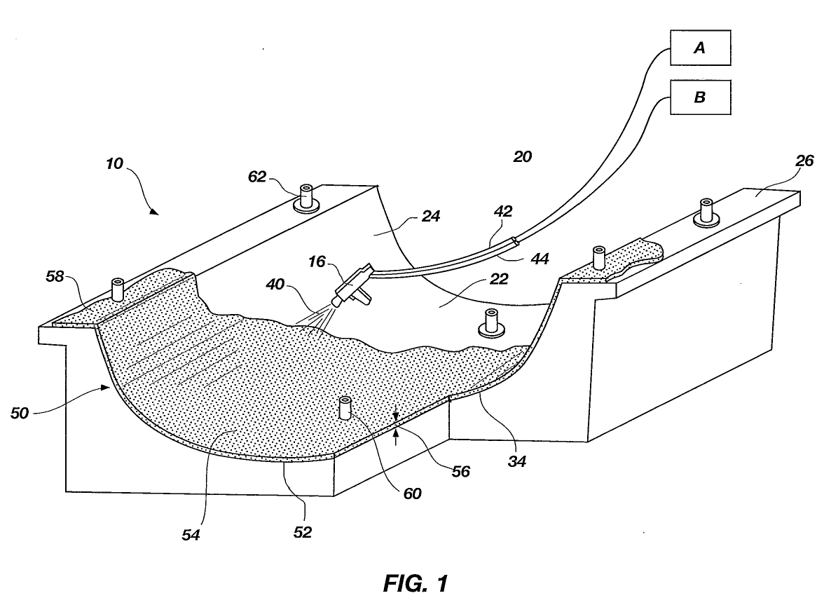

With reference now to FIG. 1, illustrated is a graphical depiction of a method of forming a multi-function vacuum bag in accordance with one exemplary embodiment of the present invention. As shown, a prepolymer composition 40, in liquid form, is applied to a surface 24 of a tooling member 20, which in this case comprises an open mold having a mold cavity 22. The prepolymer composition 40 forms a coating about the tooling member 20 that, due to its composition and application method, rapidly polymerizes, namely in a matter of seconds or minutes (depending upon the composition used), at ambient conditions, into a semi-rigid vacuum bag 50 having a shape substantially conforming to the surface 24 of the tooling member 20.

The formed vacuum bag 50 comprises an inner surface 52, an outer surface 54, and a thickness 56 which may be uniform or non-uniform. Indeed, as discussed below, the thickness of the vacuum bag 50 may be increased in one or more regions of the vacuum bag 50 for one or more purposes, such as to provide a caul function. The vacuum bag 50 also comprises a periphery 58, which at least partially covers a sealing surface 26 of the tooling member 20.

The prepolymer composition may comprise any component or group of components which combine to form a coating that rapidly polymerizes (preferably within seconds or minutes depending upon the composition), at ambient conditions, about a surface to which it is applied to form a semi-rigid, flexible member. In one exemplary embodiment, the prepolymer may comprise a polyurea-based composition made by combining an “A” side isocyanate component (shown as being communicated through a flow tube 42) with a “B” side resin blend component (shown as being communicated through a flow tube 44), wherein these two components may be mixed in a spray device 16 and dispensed therefrom. The isocyanate component may be further broken down into an isocyanate building block, such as an MDI monomer, connected to a flexible link with a urethane bond. In the preferred embodiment above, the isocyanate building block may have reactive end groups selected from a group consisting of polyol or amine, and the flexible link can be selected from a group consisting of polyether, silicone, polybutadiene or other low ‘Tg’ segments.

To enable rapid polymerization, the isocyanate component, or “A” side, is mixed with the resin blend, or “B” side component, which in one embodiment, as discussed above, comprises an amine-terminated polymer resin. When mixed together, the two A and B side components combine by way of a urea bond to form a long, polyurea-based molecule, which then cross-links with other similar molecules to form the semi-rigid, reusable polymer vacuum bag of the present invention.

The present invention contemplates many different types or variations of the prepolymer composition. For purposes of discussion, an exemplary first specific type of polyurea-based prepolymer composition comprises a two part polyurea, namely an “A” side polymeric MDI comprised of diphenylmethane-diisocyanate (MDI), and modified MDI; and a “B” side polymeric polyol comprised of aliphatic amines (polyoxypropylene diamine), di-ethyl toluene diamine (DETDA). The “A” side is present in an amount by weight between 25 and 40 percent, and preferably between 30 and 35 percent. The “B” side is present in an amount by weight between 60 and 75 percent, and preferably between 65 and 70 percent. This composition is available under the several products being marketed as Reactamine®, or as comprising Reactamine® technology.

An exemplary second specific type of polyurea-based prepolymer composition comprises a two part polyurea, namely an “A” side aromatic isocyanate comprised of polyurethane prepolymer, diphenylmethane-diisocyanate (MDI), and alkylene carbonate; and a “B” side aromatic polyurea comprised of polyoxyalkyleneamine, diethyltoluenediamine (DETDA), and polyoxyalkyleneamine carbon black. The “A” side is present in an amount by weight between 40 and 60 percent, and preferably between 45 and 55 percent. The “B” side is present in an amount by weight between 40 and 60 percent, and preferably between 45 and 55 percent. This composition is available from Bay Systems North America.

It is noted that these two compositions are not meant to be limiting in any way. Indeed, those skilled in the art may realize other compositions that may be used to provide a multi-function vacuum bag as taught and described herein.

A polyurea-based prepolymer vacuum bag 50 provides significant improvements over prior related vacuum bags. For example, the vacuum bag 50 is rigid enough to maintain the shape of the tooling member even after removal, yet flexible enough to bend with movement and to provide an airtight seal when placed against the sealing surface of the tooling member 20. Furthermore, the polyurea-based prepolymer vacuum bag 50 is durable and robust. In fact, in some manufacturing processes that utilize relatively low temperatures to cure the composite article, the vacuum bag 50 may be durable and robust enough to withstand repeated use during several manufacturing cycles. Furthermore, the vacuum bag 50 may be configured to withstand or endure curing cycles in an autoclave or oven at known elevated temperatures for extended periods of time. One additional advantage over traditional or existing vacuum bags is that the polyurea-based material may be configured to be translucent, which enables operators to view and monitor a resin front in a resin infusion process as it advances through the assembled lay-up, which will help operators verify that all portions of the fiber preform have been wetted with resin.

Referring again to FIG. 1, the tooling member 20 has a mold cavity 22 forming a concave configuration. However, this is not to be limiting in any way. The tooling member 20 may comprise any desirable shape, and the multi-function bag formed thereabout. Indeed, the prepolymer composition works equally well with tooling members having a flat or convex configuration, as well as arbitrary surface contours, and various combinations of these. The prepolymer composition may also be applied over surfaces having various protrusions or peaks, valleys or recesses, and combinations of these. In other words, the prepolymer composition may be applied over a surface having any contour due to the rapid spray-on capabilities of the prepolymer composition, and the rapid polymerization of the prepolymer composition allowing it to take on a solidified form shortly after being applied to the surface.

While not a requirement, the surface 24 and sealing surfaces 26 of the tooling member 20 may be prepared prior to applying the prepolymer composition onto these surfaces to form the vacuum bag 50. This preparation may consist of one or more of cleaning the surfaces of the tooling member 20 to remove all residues and other foreign objects and coating the tooling member with a mold release agent or release layer 34 to ensure that the vacuum bag 50 readily releases from the tooling member 20 after polymerization without tearing or ripping, therefore maintaining the structural integrity of the vacuum bag 50. If a texture other than tool surface is desired, a textured material may be used, wherein the prepolymer composition is applied over the textured material. Once the vacuum bag is formed, the textured material may be removed or separated from the vacuum bag 50, thus leaving the vacuum bag 50 with at least a partially textured surface.

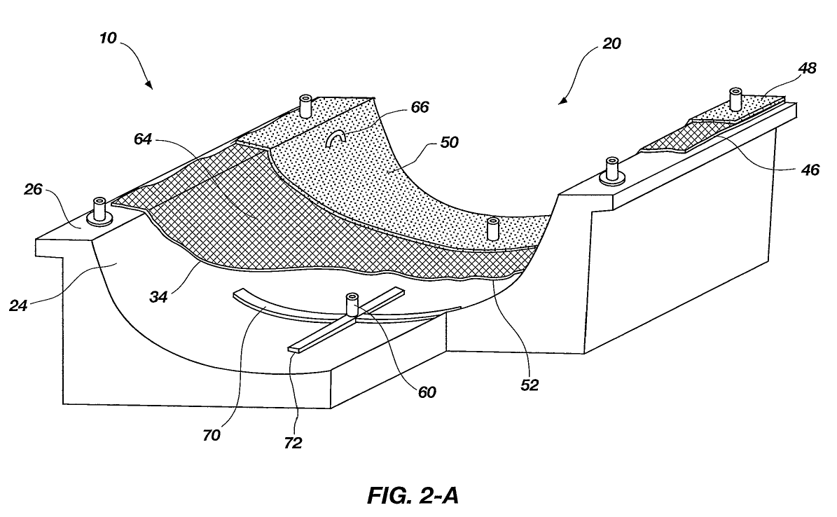

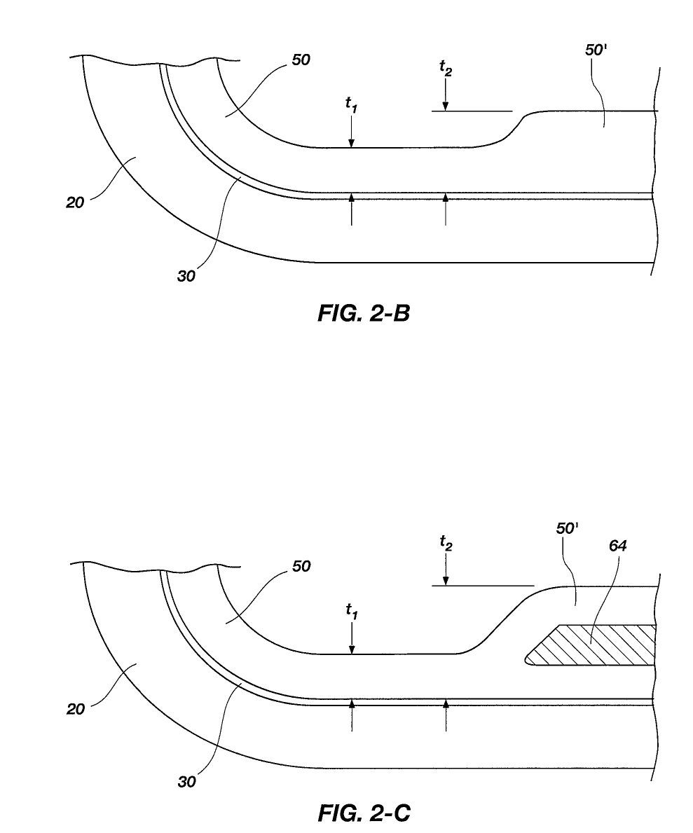

In another exemplary embodiment, at least one vacuum suction port 62 or other structural member (resin injection port, reinforcement fiber, etc.) may be positioned on top of the release layer to become encased within the polymerizing prepolymer composition as it is applied, with the intention that the ports (or other structures) become an integral part of the vacuum bag 50 once formed, and removed from the mold cavity 22. This concept is discussed further below in reference to FIG. 2.

Integrating vacuum ports and other structural members into the body of the vacuum bag provides significant advantages over prior related vacuum bags. For example, following existing practices, vacuum ports are normally added after the impervious sheet has been laid down over the fiber reinforcement preforms or prepregs. This requires technicians to make a hole in the sheet, install the port, and then seal up the sheet around the port. The process is not only labor intensive, but cutting and sealing the impervious liner always creates the potential for an air leak when drawing the vacuum. By integrating the vacuum ports into the bag during the spraying process, a tight seal is made certain and several previous steps in these conventional existing bag forming practices are eliminated.

It is well known that only one or two vacuum suction ports are required during a vacuum bagging process, but both vacuum suction ports 62 and resin injection ports 60 are needed in a resin infusion process, usually several of each. Placement of the two types of ports varies widely according to the size and shape of the composite part to be fabricated and the expertise of the manufacture. Placement of the ports to control the flow resin through the fiber preform is strategically determined by technicians, and such placement or number of ports is not in any way limited that depicted in the figures. These were selected merely for illustrative purposes. Indeed, the resin injection ports and vacuum suction ports may be placed over the release layer and about the tooling member 20 at any location or any number of locations.

According to the preferred embodiment shown in FIG. 1, after polymerization is complete the vacuum bag 50 may be removed from the tooling member 20 and later used in a vacuum bagging, resin infusion, or other manufacturing process for the fabrication of fiber-reinforced composite articles or parts. As polymerization of the vacuum bag 50 takes place within a matter of seconds or minutes, it is anticipated that the lengthiest part of forming the vacuum bag will be the steps needed to prepare the tooling member 20 by applying the release layer and locating or positioning the resin injection ports and/or vacuum suction ports. Consequently, and according to the method of the present invention, the overall time needed to form a vacuum bag and to fabricate a composite article is significantly reduced compared with prior related composite manufacturing processes.

With reference to FIG. 2-A, illustrated is a perspective, cut-away view of an exemplary graphical depiction of a method for forming a vacuum bag similar to that of FIG. 1. Unlike that shown in FIG. 1, however, the vacuum bag 50 comprises one or more components shown as being integrated into its structure during the formation stages. As discussed above, such components may comprise resin injection ports, vacuum ports, reinforcement fibers or materials, and any others known in the art.

As discussed briefly above, one of the inherent functions of the multi-function vacuum bag is to provide a caul function. As is well know in the art, a caul, sometimes referred to as a pressure pad or a pressure intensifier, is designed to provide increased pressure in selected areas to aid in or enhance part definition. In many conventional composite manufacturing processes, a separate and independent caul sheet or layer is added when needed. This independent caul is intended to be operable with the lay-up, any breather material, and the vacuum bag overlaid thereon. Having a separate caul increases production times, as well as expense. In addition, it is often difficult to achieve the desired part definition as a separate caul can shift during the manufacturing process, thus leading to defective parts. Trial and error is often employed to ensure proper positioning of a separate caul material.

The inherent caul function of the multi-function vacuum bag is contemplated in at least two variations. The first variation is to configure a vacuum bag, intended to be used in a traditional way (e.g., in a vacuum bagging, infusion or other manufacturing process in which a vacuum bag is used), with a caul function. A vacuum bag to be formed in accordance with the methods described herein using the prepolymer composition may be configured with one or more caul functioning regions or areas. These select areas may be so configured and formed by building up the thickness of the vacuum bag by applying additional prepolymer composition. Alternatively, these areas may be configured and formed by embedding or incorporating or integrating a reinforcement material having a higher degree of rigidity than the vacuum bag itself into the vacuum bag at the time of its formation, meaning that the prepolymer composition is sprayed around the reinforcement material. It is noted that a combination of both of these configurations is also contemplated, namely additional prepolymer composition to build up the thickness of the vacuum bag around an integrated reinforcement material.

FIG. 2-B illustrates the first described scenario, wherein a caul region 50′ of the vacuum bag 50 comprises a thickness t₂, formed by applying additional amounts of the prepolymer composition to this particular select area. As can be seen, this thickness t₂ is greater than the thickness t₁ of other areas of the vacuum bag 50. One or more built-up areas or caul regions of the vacuum bag 50 may be formed as the prepolymer composition is applied to the tooling member 20 over the release agent 30.

FIG. 2-C illustrates the second described scenario, wherein the caul region 50′ of the vacuum bag 50 comprises a thickness t₂, formed by embedding a reinforcement material 64 into the vacuum bag 50. A first or initial layer of the prepolymer composition may be applied (preferably by spraying) to the tooling member 20 about the release agent 30 and the reinforcement material 64 subsequently disposed over the initial layer to define the caul region 50′ intended to provide a caul function, either during or after the polymerization phase of the first layer. Once the reinforcement material is properly positioned, a second layer of the prepolymer composition may be applied over the reinforcement material 64, bonding with the first layer and completely encasing the reinforcement fibers 64, to achieve or form the caul region 50′ having an increased thickness t₂. As can be seen, this thickness t₂ is greater than the thickness t₁ of other areas of the vacuum bag 50.

The second variation in providing a caul function is using the prepolymer composition to form an entire caul layer or material rather than incorporating a caul function within a vacuum bag. In other words, it is contemplated that the prepolymer composition may be prepared and so applied so as to form a caul material that may be used in conjunction with other manufacturing components. This particular variation of the caul function aspect is likely to find application in the manufacture of large composite articles where large tooling members are employed. Of course, the caul formed in accordance with this particular method may also provide a sealing function, if needed.

With reference again to FIG. 2-A, reinforcement materials 64 may be embedded or integrated into the vacuum bag 50 for purposes other than to provide a caul function. Indeed, reinforcement materials 64 may comprise many different configurations and properties, and may be selectively added to the vacuum bag 50 to define areas of increased stiffness, rigidity, and/or strength. This is especially important when the tooling member 20 is large and the bag is configured to cover a large surface area, and where it is still desirable to move the bag as a single, unitary piece.

Likewise, additional prepolymer composition may be selectively applied about various areas or regions of the tooling member as needed, to build up and increase the thickness of the vacuum bag in these areas, for the purpose of defining areas of increased stiffness, rigidity, and/or strength.

Using one or both of these methods, a vacuum bag may be formed that comprises non-uniform strength and stiffness properties, which may be beneficial in fabricating particular types of composite articles. Indeed areas of the vacuum bag may be relatively stiff and rigid as compared to areas where no build-up or no reinforcement is provided, which areas are relatively softer and less rigid.

Providing areas of increased stiffness and rigidity functions to enhance control over the shape and finish of the completed composite article. In addition, by selectively stiffening certain areas, the vacuum bag may comprise areas that are softer and more flexible, such as around the periphery to facilitate better sealing of the vacuum bag. One particular advantageous application of a vacuum bag having areas of increased stiffness and rigidity will be in the manufacture of composite articles using a resin infusion process. Here, the vacuum bag formed in accordance with the methods taught and discussed herein can be used in a similar manner as the upper cooperatively-shaped rigid male mold used in conventional RTM or VARTM processes. However, the present invention vacuum bag can be built far quicker and at significantly less expense than the rigid metal dies often used, and can be applied to much larger tooling.

FIG. 2-A also illustrates the use of an impression member 70 designed to impart a form, shape, or grooves in the inner surface 52 of the vacuum bag 50. Unlike the various resin injection or vacuum ports, or reinforcement fibers or other components which are permanently integrated into the structure of the bag, the impression member 70 is intended to remain separate and independent from the formed vacuum bag. The function of the impression member 70 is simply to function as an component over which the prepolymer mixture is applied in order to form contour or shape within the vacuum bag that corresponds to the configuration of the impression member 70. This is accomplished by positioning the impression member on the surface of the tooling member 20 before the release layer 34 is applied. The inner surface of the vacuum bag will permanently retain the impression of the impression member 70. Simply for illustrative purposes, and as shown, a long, narrow impression member 72 may be used form the imprint of a resin flow channel leading away from a resin injection port 60. Other impression members of different configurations, such as different thicknesses, sizes and shapes, may be used to provide different surface variations in the vacuum bag. Still further, an impression member may be formed and configured to create spaces for additional layers of fiber preform, which in turn allows the composite part manufacturer to create complex articles with better mechanical characteristics.

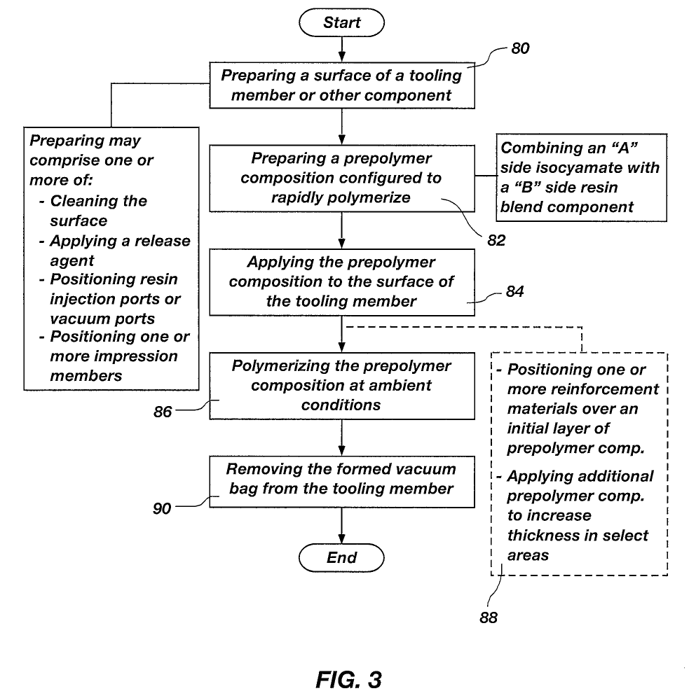

FIG. 3 illustrates a flow diagram describing an exemplary method for forming a multi-function vacuum bag in accordance with one exemplary embodiment of the present invention. Specifically, FIG. 3 illustrates a flow diagram of the various elements discussed above. As shown, the method comprises step 80, preparing one or more surfaces of a tooling member or other component to receive a prepolymer composition for the purpose of forming a pre-formed vacuum bag. Rather than a tooling member, various components such as a spacer, a previously fabricated composite article, etc. may be used as the receiving surface of the prepolymer composition to pre-form the vacuum bag. The step of preparing such surfaces may comprise steps including, but not limited to, cleaning the surface to remove debris and other contaminants, applying a release layer or release agent to the surface to facilitate removal of the vacuum bag after polymerization, setting or positioning one or more resin injection or vacuum suction ports, and/or positioning one or more impression members. Step 82 comprises preparing a prepolymer composition configured to rapidly polymerize. This step may comprise combining an “A” side isocyanate component with a “B” side resin blend component as discussed above. Step 84 comprises applying the prepolymer composition to the prepared surface of the tooling member. Step 86 comprises polymerizing the prepolymer composition in a rapid manner at ambient conditions to form a multi-function vacuum bag having a surface shape that substantially corresponds to that of the tooling member and any components positioned thereon. Step 90 comprises removing the formed vacuum bag from the tooling member after the vacuum bag has polymerized and cured. FIG. 3 further illustrates optional step 88, positioning one or more reinforcement materials over an initial layer of prepolymer composition, and/or applying additional prepolymer composition in one or more select areas to increase the thickness in these areas, each of these for one or more purposes such as to increase the stiffness and rigidity of the vacuum bag, and/or to provide a caul function.

The present invention further contemplates a similar method as that described above and shown in FIG. 3, only rather than applying the prepolymer mixture over the surface of a tooling member or other component to provide a pre-formed vacuum bag, the prepolymer mixture may be applied directly to a composite lay-up. A release agent may be applied to the lay-up prior to application of the prepolymer composition, but this may not be required as will be obvious to one skilled in the art. In addition, various resin injection ports, vacuum ports, impression members, reinforcement materials, etc. may be utilized in a similar manner.

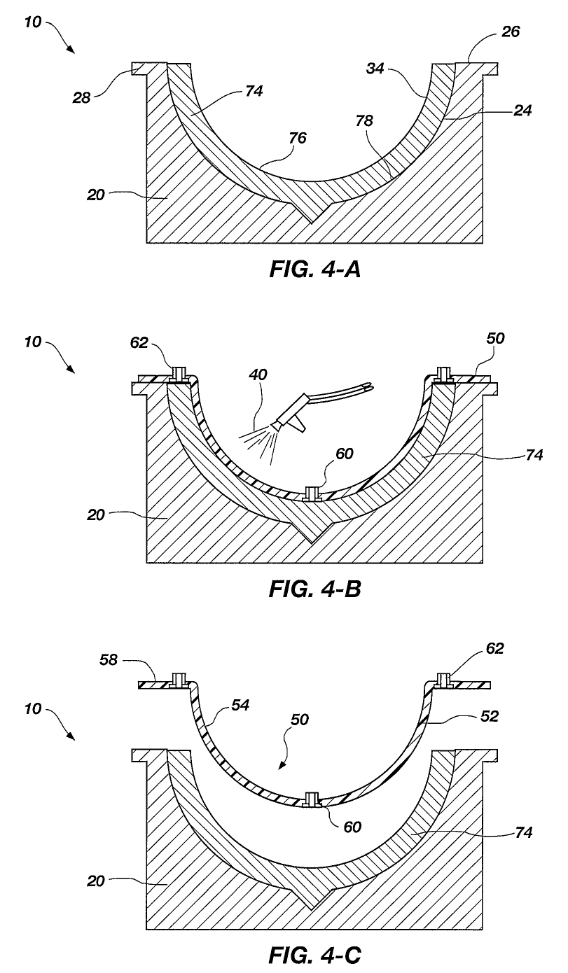

With reference to FIGS. 4-A-4-C, illustrated are various graphical depictions of a method of forming a multi-function vacuum bag in accordance with another exemplary embodiment of the present invention, wherein a spacer is used to modify the overall size, shape and/or configuration of the vacuum bag with respect to the tooling member. For instance, it may be desirable to create a vacuum bag that is slightly smaller in scale than a working surface of the tooling member about which a composite article is to be formed. As shown, the vacuum bag 50, having an inner surface 52 and an outer surface 54, is formed by applying the prepolymer composition 40 to a surface of a spacer 74 situated about the working surface of the tooling member 20. The may comprise a first surface corresponding in size and configuration to a working surface of the tooling member, and a second elevated surface also corresponding in size and configuration to the working surface of said tooling member. However, the second elevated surface comprises a different scaled size than the working surface of the tooling member, thus permitting the vacuum bag formed therefrom to comprise a different size or scale.

Specifically as shown, the spacer 74 comprises an outer or top surface 76 that corresponds to a top surface of a desired finished composite article, a bottom surface 78 that corresponds with a bottom surface of the desired finished composite article and which mates with the surface of the tooling member 20, a thickness, and an overall configuration designed to correspond to that of the desired composite article or layer to be formed. More specifically, the spacer 74 may be used to provide a vacuum bag having a contour that corresponds to the upper surface of a desired composite article to be fabricated, thus providing a more accurate fit of the vacuum bag over the composite lay-up during manufacture. The spacer 74 is intended to perform multiple functions, such as to account for a thickness of the composite article, and to facilitate formation of a vacuum bag that will better fit the lay-up over the tooling member. This procedure may be followed when the size or shape of the finished composite article relative to the size of the tooling member will not allow a vacuum bag which has been formed directly from the contoured surface of the tooling member to properly fit the top surface of the fiber preform disposed about the tooling member.

As illustrated in FIG. 4-A, the thickness of a finished composite article, or one of its intermediate layers, may be such that a vacuum bag formed directly from the surface of a tooling member would not fit properly over the composite lay-up. For instance, the vacuum bag may not match the contours of the lay-up or properly seat and seal against the sealing surfaces 26 of the tooling member 20.

Likewise, the tooling member may be configured to form a finished composite article having a non-uniform thickness, including projections, such as the keel section on a composite boat hull. As indicated, to account for such variations in thickness, as well as to form a vacuum bag having a contour that conforms to an upper surface of a composite lay-up, a spacer 74, which may be configured to substantially mimic the geometry and overall structure of the desired composite article, may be first placed about the tooling member 20 as shown in FIG. 4-B. Any impression members (not shown) may be positioned before application of the release layer 34, after which any resin injection ports 60, vacuum suction ports 62, as well as any attachment devices (not shown) that are to be integrated with the prepolymer composition 40, as described above, and formed with the vacuum bag 50, are then positioned. Once these are in place, the prepolymer composition may be applied to the spacer 74 to form the vacuum bag. As with other embodiments, reinforcement members or additional layers of prepolymer composition may be subsequently added to select areas to increase the stiffness and rigidity of the vacuum bag.

The prepolymer composition, upon polymerization, functions to conform to the top surface 76 of the spacer 74, thus creating a vacuum bag having a slightly smaller scaled inner surface 52 as compared to the surface 24 of the tooling member 20. As so formed, the finished vacuum bag 50 may then better conform to the lay-up 14 used to create the finished composite article, which lay-up 14, as stated, is similar in size and shape as the spacer 74 used to create the vacuum bag 50. As illustrated in FIG. 4-C, the formed vacuum bag 50 may be placed over the lay-up 14 in preparation for and initiation of a suitable manufacturing process.

As indicated above, alternatively rather than using a dedicated spacer, an already formed or existing composite article may be utilized as the component for forming the vacuum bag. For example, a first finished composite article may be made using standard or conventional vacuum bag forming techniques, after which the formed composite article may serve as the tool for forming or creating one or several multi-function vacuum bags in accordance with the present invention. All composite articles formed thereafter that are intended to be similar in configuration to the first may be fabricated using the multi-function vacuum bag.

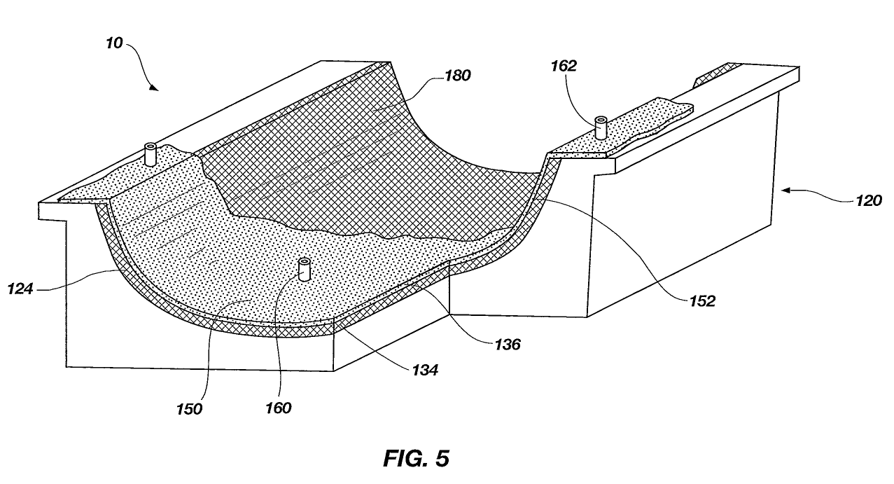

With reference to FIG. 5, illustrated is a perspective, cut-away view of resin infusion system according to one exemplary embodiment of the present invention. As shown, the resin infusion system 110 utilizes a reusable multi-function vacuum bag 150 formed in accordance with any one of the methods described above, wherein the reusable multi-function vacuum bag 150 is first formed in the tooling member 120 and integrates one or more resin injection ports 160 and vacuum suction ports 162. As in other embodiments, the vacuum bag 150 may comprise various other components and/or reinforcement members.

After the vacuum bag 150 has been cured and removed, a first release layer 134 may then be applied to the surface 124 of the tooling member 120. This first release layer 134 may be any coating or film or agent which will allow the finished composite article to readily release from the tooling member 120, as commonly known. The release layer 134 is then followed by a lay-up of reinforcement material to create a fiber preform 180 which defines the form and shape of the finished composite article. The fiber preform 180 may be assembled from any number of materials well known in the art and which may further assume a variety of configurations, from continuous fiber mats to interlocking segments to sprayed-on fibers and the like, including the use of multiple layers, all which are also well known in the art. The fiber preform 180, as described above, is also inclusive of any inserts or other components, which may be added to the reinforcement material to affect the physical properties of the finished composite article.

The inner surface 152 of the reusable vacuum bag 150 is normally configured and intended to impart a smooth, quality finish to the completed composite article. However, it may be desirable to alter the finish of the composite article in some way, in which case a second release layer 136 may be optionally applied to the top surface of the fiber preform 180 and a finishing element added, such as a texturing material. A second release layer, such as a Teflon coating, may also be applied directly to the inner surface 152 of the reusable vacuum bag 150 to improve the release of the bag from the finishing element and the formed composite article after the vacuum processing step has been completed.

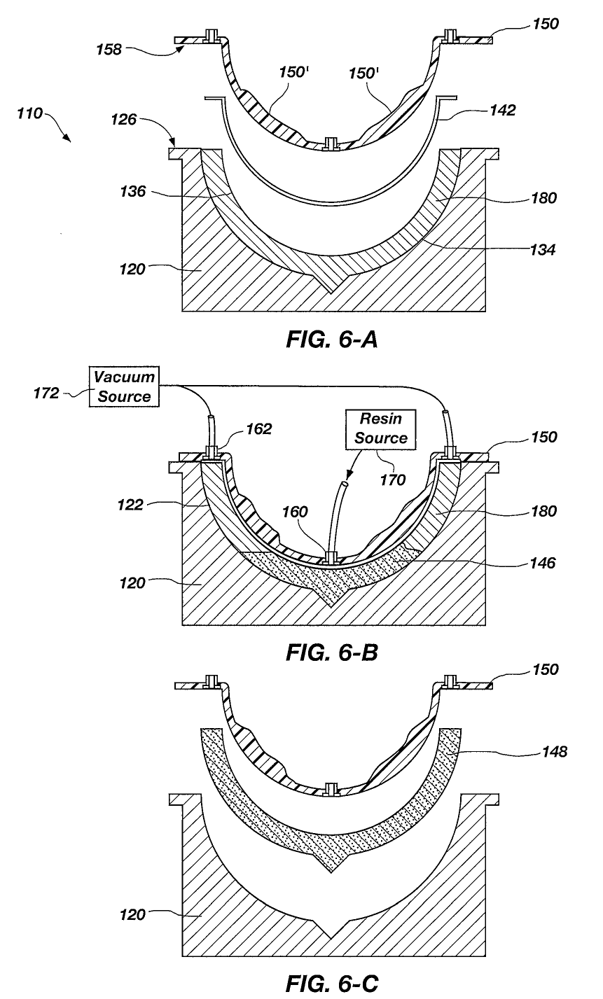

Referring now to FIG. 6-A, illustrated is a graphical depiction of a resin infusion process in accordance with another exemplary embodiment. As shown, a release layer 134 is placed on the tooling member 120, after which a lay-up of fiber preform 180 is put into position. A second release layer 136 may then be applied to the top surface of the fiber preform 180. Furthermore, a layer of distribution media 142 may optionally be placed over the fiber preform 180. The distribution media 142 can be useful in helping the resin to “sheet out” over the surface of the preform 180, from which it can then be drawn down into the fiber matrix of the preform 180 either by vacuum, gravity, or capillary action.

FIG. 6-A further illustrates the multi-function vacuum bag 150 formed in accordance with any of the methods described herein. The vacuum bag 150 comprises a periphery 158 and two areas or regions of increased thickness, shown as regions 150′. These built-up regions in the vacuum bag allow the vacuum bag to function as a caul to enhance the definition of respective areas of the formed composite article. As can be seen, the vacuum bag is configured to provide such a caul function rather than the process utilizing or requiring a separate and independent caul sheet or layer.

With reference to FIGS. 6-B and 6-C, at this point the reusable vacuum bag 150 is placed over the lay-up of the fiber preform 180 and the periphery 158 of the bag 150 is clamped or sealed against the sealing surfaces 126 (see FIG. 6-A) of the tooling member 120 to form a sealed vacuum envelope surrounding the lay-up of preform 180. An air-tight seal between the vacuum bag 150 and the tooling member 120 can be formed by any of method well-known in the art, including the application of liquid adhesive or tacky tape, such as chromium tape, continuously around the periphery of the tooling member 120.

A vacuum source 172, placed in pneumatic or fluid communication with the sealed volume between the mold cavity 122 and the vacuum bag 150 via vacuum suction ports 162, is used to draw a vacuum in the sealed vacuum envelope. Resin 146, in liquid form, from a resin source 170 is introduced, or ‘infused’, into the interior of the vacuum through resin injection ports 160. Under ideal circumstances, the vacuum bag 150 functions to shape the preform 180 to the mold, to draw the resin through the preform 180, to completely “wet” the preform 180, and to remove any air that would form voids within the completed composite article. The vacuum may be maintained while the wetted fiber preform is pressed against the tooling member 120 and cured to form the finished composite article 148 having the desired shape. Such resin infusion processes are well known in the art. However, the present invention contemplates a modified resin infusion process utilizing the reusable multi-function vacuum bag discussed herein.

After curing, the vacuum bag 150 may detached or removed from the finished composite article. If in suitable condition, the bag 150 may be used again once the finished composite article 148 is removed and a new lay-up of fiber preform installed in its place. A reusable bag that can be repeatedly used to create a plurality of like composite parts is advantageous in that there is no need to expend additional effort preparing a disposable vacuum bag over the new fiber preform, which process often takes more time than laying up the fiber preform itself. Indeed, depending upon the type of manufacturing process to which the multi-function vacuum bag will be subjected, and depending upon the composition of the multi-function vacuum bag, it may be configured to be robust and durable enough to be repeatedly used for an extended number of composite article manufacturing cycles. At any point during the life cycle of the reusable vacuum bag the tooling member can be prepared and a replacement or supplemental bag made quickly and easily.

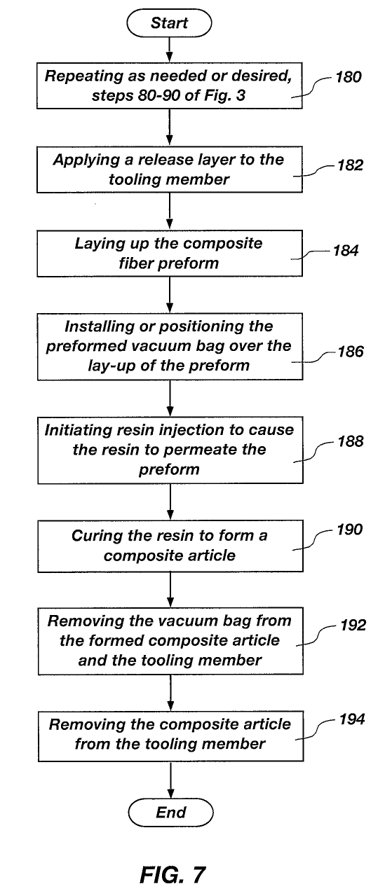

FIG. 7 illustrates a flow diagram depicting an exemplary resin infusion process for forming a composite part utilizing a reusable multi-function vacuum bag in accordance with the present invention. Specifically, FIG. 7 illustrates a flow diagram of the various elements depicted in FIGS. 5-6 and discussed above. As shown, the method comprises step 180, namely repeating as needed or desired the steps 80-90 shown in FIG. 3 and discussed above. Step 180 may also include, but is not limited to, applying a release layer to facilitate removal of the vacuum bag after polymerization. Step 182 comprises applying a release layer to the tooling member. Step 184 comprises laying up a fiber preform onto the contoured surface of the tooling member, which optionally may include, and is not limited to applying a second release layer over the fiber preform followed by an optional surfacing element and/or distribution media. Step 186 comprises installing or positioning a pre-formed multi-function vacuum bag over the tooling member and fiber preform, and sealing the bag around the periphery of the tooling member to form an airtight envelope. Step 188 comprises initiating a resin injection process to draw a vacuum and to cause resin to permeate the preform. This step includes placing the sealed volume in fluid communication with both a vacuum source and a resin source by connecting the respective ports to the appropriate systems. The resin flows into and through the fiber preform by drawing a negative pressure to remove entrapped air or gases and introducing the liquid resin into the sealed volume and allowing it flow throughout and completely wet the fiber preform while maintaining the negative pressure. Step 190 comprises curing the resin for a pre-determined time at a pre-determined temperature and pressure to form the composite article. Step 192 comprises removing the vacuum bag from the formed composite article and the tooling member and potentially reusing it again. Step 194 comprises removing the finished composite article from the tooling member.

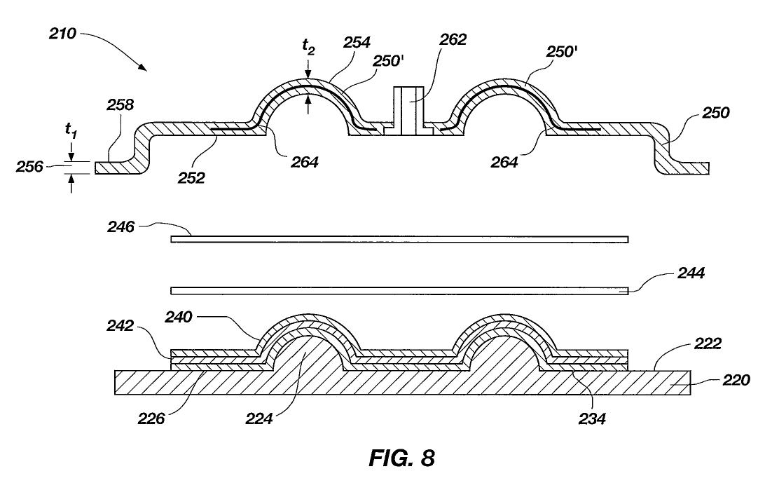

FIG. 8 illustrates an exploded side view of a graphical depiction of a vacuum bagging system 210 utilizing a multi-function vacuum bag in accordance with the present invention. A vacuum bag 250 is first formed (e.g., on the tooling member 220 or on a spacer, or on a previously fabricated composite article) using any one of the methods described herein, or obvious variants thereof. As illustrated in FIG. 8, the vacuum bag 250 comprises a thickness t₁ about much of its geometry. However, the vacuum bag 250 further comprises one or more areas of increased stiffness or rigidity, shown as areas 250′. These areas may be formed by increasing the thickness of the applied prepolymer composition to achieve a different thickness t₂ in these regions, and/or by embedding or integrating a reinforcement material between layers of the prepolymer composition, which reinforcement materials are shown as reinforcement materials 264.

As also illustrated in FIG. 8, the tooling member 220 has an upper surface 222 with a sealing portion 226. The upper surface 222 may also include contoured shapes 224 which may be protrusions (as shown in FIG. 8) or depressions, or any combination of the above as needed to form a composite part with the desired dimensions and configuration.

After the vacuum bag 250 has been formed and removed from the tooling member 220, a first release layer 234 may be applied to the contoured surface 124 of the tooling member 220. The release layer 234 may be any coating or film known in the art which will allow the finished composite article to readily release from the mold tool after curing. The release layer 234 is followed by a lay-up of pre-wetted fiber reinforcement material, or prepreg. The pre-preg may be laid up in a single thick layer, but more commonly a small number of thin prepreg plies 242 will be laid one on top the other to form a first portion of the composite article known as the laminate 240.

The next three processing layers shown are completed in accordance with standard practices that are well known in the art. An optional peel-ply 244 may laid over the prepreg plies to give the laminate a bondable finish to better adhere to the next sequence of prepreg plies. The peel-ply 244 is in turn covered by a permeable release film 246 which is configured to not bond to the laminate, and to allow air to pass through to the next layer above, as well as to allow the vacuum bag 250 to release from the prepreg. Normally a breather layer would be employed to provide a continuous air path between the laminate and the vacuum bag for the drawing of the vacuum during consolidation and debulking. However, the multi-function vacuum bag 250, due to its unique makeup, functions also as a breather to facilitate airflow and the evacuation of air and volatiles in a similar manner as a breather layer. As such, it is contemplated that in most, if not all cases, conventional breather layers may be eliminated from the manufacturing process.

The complete lay-up comprising the laminate, peel-ply and release film is then covered by the vacuum bag 250. The periphery 258 of the vacuum bag 250 is clamped or sealed against the sealing surfaces 226 of the tooling member 220 to form a sealed vacuum envelope surrounding the lay-up. An airtight seal between the vacuum bag 250 and the tooling member 220 can be formed by any of the well-known methods existing in the art, including the use of tacky tape, such as chromium tape, installed continuously around the periphery of the tooling member.

A vacuum source (not shown) is placed in pneumatic or fluid communication with the volume between the tooling member 220 and the vacuum bag 250 via the vacuum suction port 262. The vacuum source functions to create a negative pressure or vacuum environment within the sealed off volume. The drawing of the vacuum performs several functions. First, the vacuum bag 250 is firmly pressed against the pre-preg laminate 240 laid up on the tooling member 220, thereby forming the materials to the shape of tooling member. The vacuum also draws out any pockets of air which were left trapped between the layers of pre-preg material, consolidating the layers into a tighter laminate structure. Again, this is accomplished without the use of a separate and independent breather layer as this function is made possible by the vacuum bag 250.

After consolidation/debulking is completed, the vacuum bag 250 is removed along with the various processing layers. A new group of prepreg plies may be laid up over the existing or previous laminate structure, and the process repeated until the entire laminate composite part has been built up into its intended size.

It is noted that the same vacuum bag may be repeatedly used for many, if not all, of the consolidation/debulking phases of the manufacturing process. This allows for quick and easy removal of air and volatiles form a normal prepreg lay-up, and significantly reduces cycle times. Indeed, one key advantage the present invention over the prior art is that the vacuum bag is robust and durable enough to be reused for a high number of consolidation/debulking vacuum cycles. In contrast, current vacuum bags employ a plastic sheet which cannot be used to apply more than a few layers of laminates before they must be discarded and replaced, thus adding unwanted solid waste. The vacuum bag of the present invention may be used repeatedly, thereby saving the time and effort of making new bags and avoiding excess waste.

After the final group of prepreg plies has been consolidated and debulked onto the layers beneath, the entire laminate assembly, including the vacuum bag 250, may be placed in an autoclave where a vacuum is continuously drawn while the composite part is heated to curing temperature. After curing and removal from the autoclave, the vacuum bag 250 may be easily removed from the finished composite article as a result of the release film.

From this, it can be seen that the vacuum bag 250 may also be used within an elevated temperature environment, such as an autoclave or oven, where temperatures can range between 100° and 500° F. or more. Once subjected to a high temperature environment, the vacuum bag 250 will most likely not be further reusable as the vacuum bag 250 will tend to thermoform within the autoclave. However, there may be some instances in which the vacuum bag may be reused after removal from the autoclave.

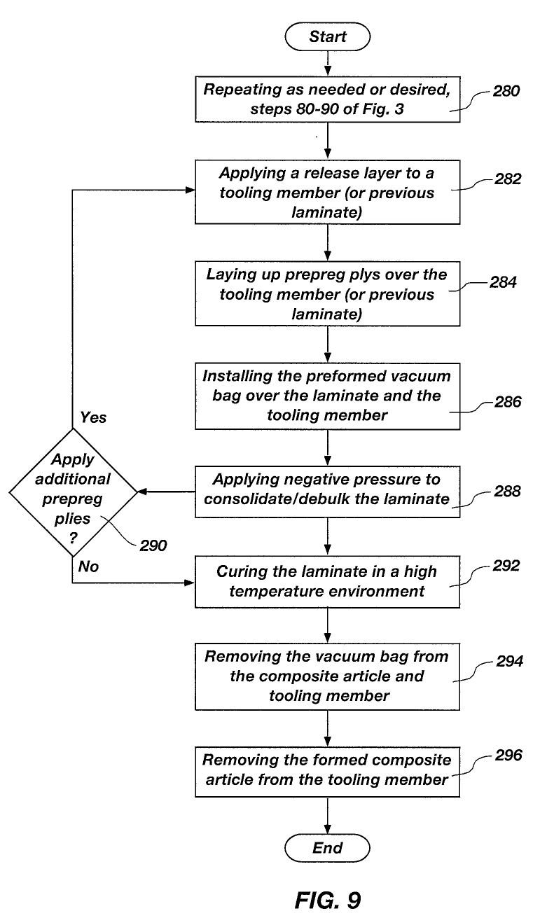

FIG. 9 illustrates a flow chart depicting an exemplary method for forming a composite part from a vacuum bagging manufacturing process utilizing a multi-function vacuum bag formed in accordance with the present invention. As shown, the method comprises step 280, repeating, as necessary or desired, the steps 80-90 of FIG. 3 to form a multi-function vacuum bag. As such, the corresponding description above is incorporated herein. The method further comprises step 282, applying a release layer to the tooling member (or to a previously consolidated and debulked prepreg ply). Step 284 comprises laying up one or more layers of prepreg plies onto the contoured surface of the tooling member to form a laminate portion, which step may include, and is not limited to applying an optional peel-ply layer, an optional release film layer (although the vacuum bag may function as a breather, a separate breather material or layer may be used if desired). Step 286 comprises installing the pre-formed vacuum bag over the tooling member and the fiber preform, and sealing the bag around the periphery of the tooling member to form an airtight envelope. Step 288 comprises applying negative pressure to consolidate/debulk the laminate. This step includes placing the sealed volume in fluid communication with a vacuum source by connecting the vacuum suction ports to the vacuum source. This step also comprises drawing a negative pressure to consolidate the laminate portion by removing entrapped air or gases from the prepreg plies. As shown in step 290, additional prepreg plies may be added. As such, the steps 282-288 may be repeated as often as necessary to form the laminate having the desired dimensions and configuration. Once formed, step 292 comprises curing the laminate in a high-temperature environment, such as an oven or autoclave for a pre-determined period of time, and at a pre-determined temperature and pressure. Step 294 comprises removing the vacuum bag from the tooling member and the finished composite article. Step 296 comprises removing the finished composite article from the tooling member.

The following examples are representative of different scenarios of the present invention. These examples are intended merely to be illustrative, and not limiting in any way.

### Example One

This prospective example is representative of a bagging system comprising a sprayable, multi-function vacuum bag designed for multi-functional use in composite parts manufacturing. Stated differently, the compositions provided herein allow the multi-function vacuum bag to function as a release, a caul, a breather layer, a vacuum bag, a pliable mold top, etc., each of which can be achieved with the single present invention vacuum bag. As discussed, providing multiple functions allows multiple conventional manufacturing processes to be avoided or eliminated, while producing high quality composite parts. In addition, depending upon the application, the vacuum bag can have multiple life cycles.

In this example, the multi-function vacuum bag comprises a prepolymer composition made up of a two part polyurea, such as those provided by BaySystems North America, and utilizes a Gusmer spray machine or equivalent for spraying. Specifically, the prepolymer composition contains the following substances and their respective proportions: Evercoat 900-A Side (Aromatic Isocyanate), present in an amount of 50% by weight (Ingredients: Polyurethane Prepolymer, Diphenylmethane Diisocyanate (MDI), Alkylene Carbonate); and Evercoat 900-B Side (Aromatic Polyurea), present in an amount of about 50% (Ingredients: Poloyoxyalkyleneamine, Diethyltoluenediamine (DETDA), Polyoxyalkyleneamine, Carbon Black).

To apply the prepolymer composition and form the multi-function vacuum bag, the prepolymer composition is sprayed onto a surface, such as the working surface of a tooling member, and removed prior to depositing the composite lay-up. For slightly contoured tools, the prepolymer composition may be sprayed upon a flat surface and subsequently cut to tool size. When the pre-formed multi-function vacuum bag is then applied to a composite lay-up, the bag forms an airtight encasement of materials to be cured. The multi-function bag presses the tool contour to the top of part. It also acts as a release layer, making the bag easily removable from the part.

Prior to applying the prepolymer composition, the tooling member or other surface may be prepped. Preparation of the surface may include cleaning the surface of the tooling member to remove all residues and other foreign objects, and coating the tooling member with a mold release agent (such as Trend Chemlease 41). If a texture other than tool surface is desired, a texture material may be laid over the surface of the tooling member.

The prepolymer composition may be applied by spraying it through a spray gun. Spraying may occur in lateral motions of 0.75-1.5 feet per second with approx. 8-12 inches between the spray gun and the surface of the tooling member, each pass slightly overlapping the last. Any number of coats may be applied until desired thickness is achieved. In most cases, the prepolymer surface will remain tacky or sticky for about 3-5 seconds after being sprayed, with full cure occurring in approximately 10 minutes. After the prepolymer has been completely cured, the resulting multi-function vacuum bag may be removed from the tooling member and examined for any defects. More specifically, the prepolymer composition may be sprayed using a Graco Gusmer H-20/35 Pro proportioning unit or suitable proportioning unit, and a Graco Gusmer Gx-8p spray gun or other suitable spray gun. The spray gun may be equipped with a round pattern control disc to spray a 4-5 in. diameter pattern. The spray gun draws Isocyanate and Polyol materials from pressurized, heated sources. These are introduced to a pressurized air supply when sprayed. Once introduced, Isocyanate (A) and Polyol(B) begin reacting to form a sticky material. Spraying the Evercoat 900 formulation results in an output of approximately 2.25 lb/min.

When spraying, the gun is held approx. 8-16 inches from part and traversed over the surface in lateral motions of 0.75-1.5 feet per second. Each sprayed pass should overlap 1-3 inches of the prior pass. After approximately 35 seconds the material reaches a moderately cured state as a flexible solid. Although the material is no longer sticky after 35 seconds, it continues curing.

After curing, the multi-function bag may then be applied within a manufacturing process for the fabrication of a composite article. Prior to doing so, the vacuum bag may further be prepared, such as by applying a mold release agent to all tool facing surfaces, except outside borders. These outside borders should be 1-2 inches wide, thus allowing for a surface to contact any applied sealant tape, which may be optional. To provide vacuum valves, the vacuum bag may be cut to provide various holes therein.

The composite lay-up may be prepared by preparing the desired composite fiber lay-up with bleeder string (DuPont Corporation) and damming tape (TMI) surrounding the entire part. The bleeder string should border all edges of any uncured fibers. At 8-12 inch intervals, lead the end of a bleeder string between damming tape and away from the part approx. 1 inch. Attach a thermocouple to tool, which may be taped to the tool with 1″ high temperature tape (such as TMI BT 8089) or as otherwise desired. A 2-4 inch wide border of pre-sprayed strips (such as Hollowflo©) may then be applied (see release Document Id@ SOBB052606) or conventional breather (such Richmond RC 3000-10A) used. Breather material should surround entire part, and cover all bleeder string ends. If a conventional breather is used, the entire inner edge may be taped to the dam or tool. This ensures that the breather material will not contact the part during the cure cycle.

Once the composite lay-up is prepared, the multi-function vacuum bag may be deposited or otherwise applied to the lay-up. The multi-function vacuum bag may be applied to the tooling member with sealant tape (such as Richmond RS 200). The bag may be placed on the tooling member before applying the sealant tape, and appropriate locations for the sealant tape noted. The vacuum bag may then be removed and the sealant tape applied to tool. The vacuum bag is then placed on the tooling member as before and the vacuum bag sealed to the tooling member via the sealant tape. In the event high air velocities in autoclave are expected, all edges of the vacuum bag may be taped using high temperature tape.

Vacuum valve bases (such as VACTYTE™ VV-7510) may then be placed over the holes formed in the vacuum bag, and sealed using a border of sealant tape. If necessary, these may be sealed using a cutout of conventional bagging material (such as VAC-PAK® HS 800), which is placed on the base and chromate. Vacuum valves may then be attached to the vacuum valve bases.

Debulking may commence for a specified time prior to cure, and the lay-up may be cured as desired. Once the lay-up is cured and the autoclave cure cycle completed, the vacuum valves and the multi-function vacuum bag may be removed from the lay-up and the tooling member.

In this example, the multi-function vacuum bag has the following physical and chemical properties when cured: appearance—smooth and glossy; color—black; maximum use temperature—350° F.; maximum use pressure—>130PSI (dependent upon thickness); tensile strength—3687; elongation—302; 00% modulus (psi)—1893; solids content—100%; shear strength (phi)—399; hardness (shore D)—49; autoclave life cycle—dependent upon application; ambient shrinkage—0.5-0.7% loss (10 days); cycle shrinkage—additional 0.65-0.8% loss.

The Evercoat 900 “A” Side of the prepolymer composition has the following characteristics: form—liquid; color—clear amber; odor—musty; boiling point/range—approximately 208° C. (406.4° F.); vapor pressure—<0.0004 mmHg @25° C. (77° F.); specific gravity—1.12 @25° C. (77° F.); solubility in water—insoluble (reacts slowly with water to liberate CO2 gas); bulk density—9.35 lb/gal.

The Evercoat 900 “B” side of the prepolymer composition ha the following characteristics: form—liquid; color—black; odor—pungent; freezing point/range—approximately <−9° C. (<15.8° F.); vapor pressure—>0.001 mmHg @ 20° C. (68° F.), 1 mmHg @ 119° C. (246.2° F.), and 10 mmHg @ 165° C. (329° F.); specific gravity—1.02 @20° C. (68° F.); bulk density—8.1 lb/gal.

There are many potential applications for the exemplary present invention multi-function bag set forth herein, such as resin infusion processes, bagging prepreg composites, reusable cauls, reusable release films, reusable bags, and damming borders. The multi-function vacuum bag performs well at cycle temperatures up to 350° F. Bag material, however, will, in most cases, yield a longer life at lower temperatures. This is because deterioration of the polyurea material may be accelerated with greater temperatures. It is contemplated that the multi-function vacuum bag will endure a single, two hour cycle at 350° F. Dropping the cure temperature 10-50 degrees will allow endurance of multiple cycles.

### Example Two

This prospective example is also representative of a bagging system comprising a sprayable, multi-function vacuum bag designed for multi-functional use in composite parts manufacturing. Stated differently, the compositions provided herein allow the multi-function vacuum bag to function as a release, a caul, a breather layer, a vacuum bag, a pliable mold top, etc., each of which can be achieved with the single present invention vacuum bag. Applications include, but are not limited to autoclave cures, resin infusion cures, prepreg de-bulking and other processes.

In this example, the multi-function vacuum bag comprises a prepolymer composition made up of a two part polyurea, and utilizes a Gusmer spray machine or equivalent for spraying. Specifically, the prepolymer composition contains the following substances and their respective proportions: an “A” side Polymeric MDI present in an amount by weight about 33% (Ingredients: Diphenylmethane—diisocyanate (MDI), and modified MDI); and a “B” side Polymeric Polyol present in an amount by weight about 67% (Ingredients: aliphatic amines (polyoxyproplylene diamine), and DI-Ethyl toluene diamine (DETDA)).

The specifications of a vacuum bag formed from this composition are: appearance—smooth and glossy; color—black; maximum use temperature—380° F.; maximum use pressure (PSI)—>130 (dependent upon thickness); thickness—>0.035 mils; ambient shrinkage—approx 0.3% (25 days); autoclave shrinkage (350° @ 2 hr)—approx 0.5% (in addition to ambient shrinkage).

Physical properties are: tensile strength (PSI)—ASTM D412—2950; elongation (%)—ASTM D412—350; 100% Modulus—ASTM D412—1620; tear strength (PLI)—ASTEM D2240—500; hardness (Shore A)—ASTM D1737—95 A; flexibility (⅛″ Mandrel)—ASTM D1737—Pass; flashpoint (° F.)—STEM Pensky-Martin—>200; taber Abrasion (mg loss)—ASTM D4060—25; CS 18 WHEEL 1 kg per 1000 cycles; viscosity—B Side—CPS—1200; viscosity—A Side—CPS—400; ratio A/B—PBV—1:2 (by volume).

Other specification include: gel time—2 minutes; tack free time—5 Minutes; handling time—15 minutes; removal from surface time—20 Minutes; fully cured time—60 minutes; A-side hose temp.—150° F.; B-side hose temp.—150° F.; block temperature—150° F.; spray pressure (PSI)—2000 (for use with Gusmer, GX-7); spray environment temp. range—30-350° F.

More specifically speaking, the “A” side comprises the following properties: odor—slightly musty; physical state—light yellow liquid; specific gravity—1.2; boiling point—decomposes at 341° C.; vapor density—8.5; vapor pressure—<0.0001 (@ 20° C.). The “B” side properties include: appearance—black/gray liquid; solubility in water—soluble; specific gravity—1.05. Note, the units for these are the same as above in Example One.

The multi-function vacuum bag is formed by spraying the prepolymer composition using a Graco Gusmer H-10/35 Pro proportioning unit or other suitable proportioning unit, and a Graco Gusmer Gx-8p spray gun or other suitable spray gun. The spray gun may be equipped with a round pattern control disc to spray a 4-5 in. diameter pattern. The gun draws Isocyanate and Polyol materials from pressurized, heated sources, which are introduced to a pressurized air supply when sprayed. Once introduced, the Isocyanate (A) and Polyol (B) begin reacting to form a tacky or sticky material. Spraying results in an output of approximately 2.25 b/min.

When spraying, the spray gun may be held approximately 8-16 inches from the lay-up and traversed over the surface in lateral motions of 0.75-1.5 feet per second. Each sprayed pass should overlap 1-3 inches of the prior pass. After approximately 3.5 seconds the material reaches a moderately cured state as a flexible solid. Although the prepolymer composition is no longer sticky after 10 seconds, it continues curing.

As with the multi-function vacuum bag of Example One, multiple applications are contemplated for use, some of which are set forth in additional detail below.

Within an autoclave cure application, a pre-sprayed multi-function vacuum bag can be placed over a composite lay-up, prepared tool, and sealed to hold vacuum integrity. When sprayed, the tool may be coated with a mold release agent to allow easy removal of the vacuum bag. The vacuum bag may also be coated with a mold release prior to being deposited over the lay-up. A vacuum may be applied to the lay-up through the tooling member, or through sprayable vacuum ports which are encased in the multi-function vacuum bag. Sprayable vacuum parts can be removed following cure(s). Conventional vacuum ports may also be placed over holes cut into the multi-function vacuum bag with conventional bag pieces being sealed to the tooling member. Alternatively, the prepolymer composition may be sprayed directly onto the lay-up to function as a bag, but such a bag will not be reusable. In addition, in this case, the lay-up may be covered with FEP or a similar release material.

Functioning as a caul to ensure part definition, a multi-function vacuum bag may be placed on the top surface of the lay-up. Thermal forming and elongation characteristics of the material will allow the multi-function vacuum bag, serving as a caul, to press in to the part of detailed part definition. As with the pre-formed sprayed bag, the caul should be sprayed prior to lay-up, at the desired thickness, to provide relief for the part being made. It is noted that the multi-function vacuum bag can function simultaneously as a vacuum bag and a caul.

A pre-formed sprayed multi-function vacuum bag/caul may also be used as a release material during cure cycles. To use as a release, the sprayed bag/caul should be coated with a mold release agent.

The multi-function vacuum bag can incorporate breather characteristics. The normal texture of the material allows air flow to be distributed throughout the part lay-up surface. For additional air movement, a textured surface can be created by spraying the prepolymer composition over a textured material or surface, thus creating a textured imprint in the surface of the vacuum bag. This texture can consist of any type of mesh or web material, such as one having connected or raised channels.

The multi-function vacuum bag may be used as a re-usable bag for de-bulking. The multi-function vacuum bag, along with a re-usable seal, can be re-used several times (>20) for de-bulking. This allows for quick and easy removal of air/volatiles from a normal prepreg lay-up. Manufacturing processes that use prepreg part de-bulking, can use the present invention multi-function vacuum bag to replace existing nylon de-bulking processes.

The multi-function vacuum bag may also easily be used for infusion cures. The multi-function vacuum bag has characteristics that may allow it to provide a better and more desirable material for infusion over conventional materials.

From the description herein, it is apparent that the present invention multi-function vacuum bag and associated methods of use offer significant advantages over the prior art. The multi-function bag greatly speeds the process of assembling new bags, advantageously incorporates or integrates resin injection ports, vacuum suction ports, reinforcement materials, and/or flow channels within the structure of the bag itself. The methods are highly adaptable and can be applied to tooling members having a wide variety of sizes and shapes, from the large molds used in resin infusion processes to the much smaller molds used in traditional vacuum bagging processes. Moreover, the methods naturally eliminate problems related to folds and wrinkles in the bag film, greatly improving the surface finish of the completed part and reducing the probability of leaks forming at seams in the bag film. And finally, the methods provide for a vacuum bag that reduces the amount of solid waste generated during the manufacture of composite components by reducing the need to throw away used bags each time a composite part is formed.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A method for forming a multi-function vacuum bag for use in the manufacture of a composite article, said method comprising:
applying a prepolymer composition configured for rapid polymerization at ambient temperatures over a surface;
rapidly polymerizing said prepolymer composition to form a multi-function vacuum bag having a periphery and a shape substantially conforming to said surface;
removing said vacuum bag from said surface; and
applying said formed vacuum bag within a composite article manufacturing process.

2. The method of claim 1, further comprising applying additional prepolymer composition to increase a thickness of at least a portion of said vacuum bag, said increased thickness providing said vacuum bag with regions of increased strength, stiffness and rigidity.

3. The method of claim 1, further comprising applying additional prepolymer composition to increase a thickness of at least a portion of said vacuum bag sufficient to enable said formed vacuum bag to function as a caul.

4. The method of claim 1, further comprising integrally embedding a reinforcement material in said vacuum bag between layers of said prepolymer composition, said reinforcement material providing said vacuum bag with regions of increased strength, stiffness and rigidity.

5. The method of claim 1, further comprising texturing, at least partially, a surface of said vacuum bag, thus being adapted to facilitate airflow about said surface.

6. The method of claim 5, wherein said step of texturing comprises applying said prepolymer composition over one or both of a textured surface and a textured material to form texture within a surface of said vacuum bag upon removing said vacuum bag from said textured surface and/or said textured material.

7. The method of claim 1, further comprising configuring said prepolymer composition to be translucent upon curing, thus permitting operators to monitor progression of a resin front during a resin infusion process.

8. The method of claim 1, further comprising preparing said surface prior to said step of applying said prepolymer composition.

9. The method of claim 1, further comprising:
positioning one or more structural members about said surface;
applying said prepolymer composition over said surface and said structural members; and
rapidly polymerizing said prepolymer composition to form said multi-function vacuum bag having said structural members integrally formed and encased therein.

10. The method of claim 1, further comprising:
positioning one or more impression members about said surface;
applying said prepolymer composition over said surface and said impression members; and
rapidly polymerizing said prepolymer composition to form said multi-function vacuum bag;
removing said vacuum bag from said surface and said impression members, said vacuum bag comprising surface variations as imparted by said impression members.

11. The method of claim 9, wherein said structural members are selected from the group consisting of vacuum ports, resin injection ports, reinforcement fibers, and any combination of these.

12. The method of claim 1, wherein said steps of applying and rapidly polymerizing are adapted to produce a formation designed to function solely as a caul operable with other composite article manufacturing components in producing a composite article.

13. The method of claim 1, wherein said step of applying comprises applying said prepolymer composition to one of a tooling member, a spacer, a previously fabricated composite article, a composite lay-up, and any combination of these.

14. The method of claim 1, wherein said prepolymer composition is adapted to rapidly polymerize within 5 seconds and 30 minutes.

15. A method for making a multi-function vacuum bag for use in a process for the manufacture of a composite article, said method comprising:
obtaining an isocyanate component comprising an isocyanate building block connected to a flexible link with a urethane bond;
obtaining a resin blend component comprising an amine-terminated polymer resin;
mixing said isocyanate component with said resin blend component to obtain a polyurea prepolymer composition, said polyurea prepolymer mixture being configured for rapid polymerization at ambient temperatures;
applying said polyurea prepolymer composition over a surface;
rapidly polymerizing said polyurea prepolymer composition to form a multi-function vacuum bag having a periphery and a shape substantially conforming to said surface; and
removing said vacuum bag from said surface.

16. A method for forming a multi-function vacuum bag for use in a process directed at the manufacture of a composite article, said method comprising:
positioning a spacer within a tooling member, said spacer having a first surface corresponding in size and configuration to a working surface of said tooling member, and a second elevated surface also corresponding in size and configuration to said working surface of said tooling member, said second elevated surface having a different scaled size than said working surface of said tooling member;
applying a prepolymer composition configured for rapid polymerization at ambient temperatures over said second elevated surface of said spacer;
rapidly polymerizing said prepolymer composition to form a multi-function vacuum bag having a periphery and a shape substantially conforming to said surface of said spacer;
removing said vacuum bag from said surface of said spacer; and
applying said formed vacuum bag within a composite article manufacturing process.

17. The method of claim 16, wherein said spacer comprises a previously fabricated composite article having a size and geometry similar to a desired composite article to be manufactured using said formed vacuum bag.

18. A method for manufacturing a composite article comprising:
obtaining a tooling member defining a working surface;
pre-forming a multi-function vacuum bag operable with the working surface, said multi-function vacuum bag comprising a prepolymer composition;
disposing a composite lay-up about said working surface of said tooling member, said composite lay-up being adapted to form a composite article;
applying said pre-formed multi-function vacuum bag about said composite lay-up; and
performing further processing steps to complete fabrication of said composite article.

19. The method of claim 18, further comprising applying a release agent to said working surface of said tooling member prior to said step of laying up said one or more composite materials.

20. The method of claim 18, further comprising applying a release agent to said composite lay-up prior to receiving said vacuum bag.

21. The method of claim 18, wherein said pre-forming said multi-function bag comprises spraying a mixed, liquid prepolymer composition about a surface, and rapidly polymerizing said prepolymer composition.

22. The method of claim 18, further comprising reusing said pre-formed multi-function vacuum bag to fabricate additional composite articles.

23. A method for manufacturing a composite article comprising:
obtaining a tooling member defining a working surface;
disposing a composite lay-up about said working surface of said tooling member, said composite lay-up being adapted to form a composite article;
applying a prepolymer composition configured for rapid polymerization at ambient temperatures over a surface of said composite lay-up;
rapidly polymerizing said prepolymer composition to form a multi-function vacuum bag having a periphery and a shape substantially conforming to said surface of said composite lay-up, said multi-function vacuum bag being operable with said tooling member to seal said composite lay-up; and
performing further processing steps to complete fabrication of said composite article.

24. A multi-function vacuum bag comprising:
a prepolymer composition comprising a polyurea-based composition formed by mixing an “A” side isocyanate component with a “B” side resin blend component; and
a configuration operable to facilitate fabrication of a composite article.

25. The multi-function vacuum bag of claim 24, wherein said isocyanate component comprises an isocyanate building block connected to a flexible link with a urethane bond, and said resin blend component comprises an amine-terminated polymer resin.

26. The multi-function vacuum bag of claim 25, wherein said isocyanate building block comprises a reactive end group selected from a group consisting of polyol and amine, and wherein said flexible link is selected from a group consisting of polyether, silicone, polybutadiene and other low ‘Tg’ segments.

27. The multi-function vacuum bag of claim 24, wherein said prepolymer composition comprises a two part polyurea, comprising:
an “A” side comprised of diphenylmethane-diisocyanate, and modified diphenylmethane-diisocyanate; and
a “B” side polymeric polyol comprised of aliphatic amines in the form of polyoxypropylene diamine, and di-ethyl toluene diamine.

28. The multi-function vacuum bag of claim 27, wherein said “A” side is present in an amount by weight between 25 and 40 percent, and wherein said “B” side is present in an amount by weight between 60 and 75 percent.

29. The multi-function vacuum bag of claim 24, wherein said prepolymer composition comprises a two part polyurea, comprising:
an “A” side aromatic isocyanate comprised of polyurethane prepolymer, diphenylmethane-diisocyanate (MDI), and alkylene carbonate; and
a “B” side aromatic polyurea comprised of polyoxyalkyleneamine, diethyltoluenediamine, and polyoxyalkyleneamine carbon black.

30. The multi-function vacuum bag of claim 29, wherein said “A” side is present in an amount by weight between 40 and 60 percent, and wherein said “B” side is present in an amount by weight between 40 and 60 percent.

31. The multi-function vacuum bag of claim 24, further comprising a structural member supported within said prepolymer composition.

32. The multi-function vacuum bag of claim 31, wherein said structural member is selected from the group consisting of vacuum ports, resin injection ports, reinforcement fibers, and any combination of these.

33. The multi-function vacuum bag of claim 24, further comprising a region of increased thickness intended to impart increased strength, stiffness and rigidity to said multi-function vacuum bag.

34. The multi-function vacuum bag of claim 33, wherein said region of increased thickness comprises a build-up of additional prepolymer composition.

35. The multi-function vacuum bag of claim 33, wherein said region of increased thickness comprises a reinforcement member embedded within said prepolymer composition.

36. The multi-function vacuum bag of claim 24, wherein said configuration is adapted to facilitate function of said multi-function vacuum bag as a caul.

37. The multi-function vacuum bag of claim 24, wherein said configuration comprises a surface having a texture formed therein to facilitate airflow about said surface.

38. The multi-function vacuum bag of claim 24, wherein said configuration comprises a surface having one or more variations formed therein, as formed by applying said prepolymer composition over an impression member.
